(19) United States
(12) Patent Application Publication
(10) Pub. No.: US 2025/0305648 A1
(43) Pub. Date: Oct. 2, 2025

(54) ELECTRONIC CANDLE

(71) Applicant: Dongguan Shuiquanzi Industrial Co., Ltd., Dongguan (CN)

(72) Inventor: Huilin She, Dongguan (CN)

(21) Appl. No.: 19/236,990

(22) Filed: Jun. 13, 2025

Related U.S. Application Data
(63) Continuation-in-part of application No. 18/790,422, filed on Jul. 31, 2024.

(30) Foreign Application Priority Data
Aug. 4, 2023 (CN) 202310978490.1
Aug. 4, 2023 (CN) 202322091015.0
Apr. 25, 2025 (CN) 202520813186.6

(51) Int. Cl. F21S 6/00; F21S 4/26; F21S 9/02; F21S 10/04; F21V 3/02; F21V 15/01; F21V 19/00; F21V 23/00; F21V 23/04; F21W 121/00; F21Y 115/10

(52) U.S. Cl. CPC F21S 6/001; F21S 4/26; F21S 9/02; F21S 10/04; F21V 3/02; F21V 15/01; F21V 19/002; F21V 23/004; F21V 23/04; F21W 2121/00; F21Y 2115/10

(57) ABSTRACT

An electronic candle includes a paraffin housing and a light string. The paraffin housing is made of paraffin, the paraffin housing includes an outer surface. The light string is arranged inside the paraffin housing without protruding out of the outer surface of the paraffin housing. The electronic candle further includes a core assembly electrically connected to the light string.

### CROSS REFERENCE TO RELATED APPLICATIONS

The present application is a continuation-in-part application of the U.S. patent application Ser. No. 18/790,422, filed on Jul. 31, 2024, contents of which are incorporated by reference herein in their entirety.

The present application claims the priority of Chinese patent application No. 202520813186.6, filed on Apr. 25, 2025; Chinese patent application No. 202310978490.1, filed on Aug. 4, 2023; Chinese patent application No. 202322091015.0, filed on Aug. 4, 2023, contents of each of which are incorporated herein by its entirety.

### FIELD

The present disclosure relates to the field of candles, and particularly to an electronic candle.

### BACKGROUND

Electronic candles have the advantages of being smokeless, safe and durable, and are widely used as substitutes for traditional candles in various scenarios. In conventional electronic candles, a light string is typically wound around an outer surface of a paraffin housing, and the light beads and wires of the light string are exposed outside, which compromises aesthetics and results in a relatively small illuminated area when the light string is lit.

Therefore, improvements to existing electronic candles are needed to address the above deficiencies.

### SUMMARY

An electronic candle includes a paraffin housing and a light string. The paraffin housing is made of paraffin, the paraffin housing includes an outer surface. The light string is arranged inside the paraffin housing without protruding beyond the outer surface of the paraffin housing. The electronic candle further includes a core assembly electrically connected to the light string.

### BRIEF DESCRIPTION OF THE DRAWINGS

To provide a clearer illustration of the technical solutions in the embodiments of the present disclosure or in the prior art, a brief introduction will be given to the drawings used in the description of the embodiments or the prior art. It is obvious that the drawings described below are merely some embodiments of the present disclosure, and for those skilled in the art, other drawings can be obtained based on these drawings without creative efforts.

FIG. 1 is a structural schematic view of an electronic candle according to an embodiment of the present disclosure.

FIG. 2 is another structural schematic view of the electronic candle according to an embodiment of the present disclosure.

FIG. 3 is a cross-sectional view of the electronic candle according to an embodiment of the present disclosure.

FIG. 4 is an exploded view of the electronic candle according to an embodiment of the present disclosure.

FIG. 5 is a partially exploded view of the electronic candle according to an embodiment of the present disclosure.

FIG. 6 is a partial structural schematic view of a core assembly according to an embodiment of the present disclosure.

FIG. 7 is a partially exploded view of the core assembly according to an embodiment of the present disclosure.

FIG. 8 is a structural schematic view of another electronic candle according to an embodiment of the present disclosure.

FIG. 9 is a structural schematic view of a paraffin, pouring mold according to an embodiment of the present disclosure.

FIG. 10 is a cross-sectional view of the paraffin, pouring mold according to an embodiment of the present disclosure.

FIG. 11 is an enlarged view of portion A shown in FIG. 4.

FIG. 12 is a structural schematic view of an inner mold and a light string according to an embodiment of the present disclosure.

### REFERENCE NUMERALS IN THE DRAWINGS

1, paraffin housing; 11, outer surface; 12, inner surface; 13, first end; 131, end surface; 14, second end; 141, step surface; 15, hollow cavity; 16, through hole; 2, light string; 21, light beads; 211, lighting element; 212, encapsulation layer; 22, wire; 23, illumination zones; 3, core assembly; 31, battery compartment; 311, bottom surface; 312, receiving cavity; 313, protruding flange; 314, slot; 315, U-shaped plates; 316, base; 317, detachable cover; 32, PCBA; 321, third end; 322, fourth end; 33, light head; 34, battery; 35, switch; 36, light head cover; 4, inner mold; 41, circumferential outer surface; 42, protruding ribs; 43, protruding post; 44, top surface; 5, outer mold; 6, mold cavity.

### DETAILED DESCRIPTION

Unless otherwise defined, all technical and scientific terms used herein have the same meaning as commonly understood by those skilled in the art to which this disclosure belongs. The terms used in the description of the application herein are intended for describing particular embodiments only and are not intended to limit the present disclosure. In the description, claims, and the above drawings of the present disclosure, the terms “comprising” and “having”, as well as their variants, are intended to convey a non, exclusive inclusion. The terms “first”, “second”, etc., as used herein, are intended to distinguish between different objects, rather than to describe a particular order.

Reference to “embodiments” herein implies that a particular feature, structure, or characteristic described in connection with an embodiment may be included in at least one embodiment of the present disclosure. The appearance of the phrase at various places in the specification does not necessarily refer to the same embodiment, nor is it a separate or alternative embodiment that is mutually exclusive of other embodiments. One skilled in the art would explicitly and implicitly understand that the embodiments described herein can be combined with other embodiments.

In order to enable those skilled in the art to better understand the technical solutions of the present disclosure, the technical solutions in the embodiments of the present disclosure will be clearly and completely described below with reference to the accompanying drawings.

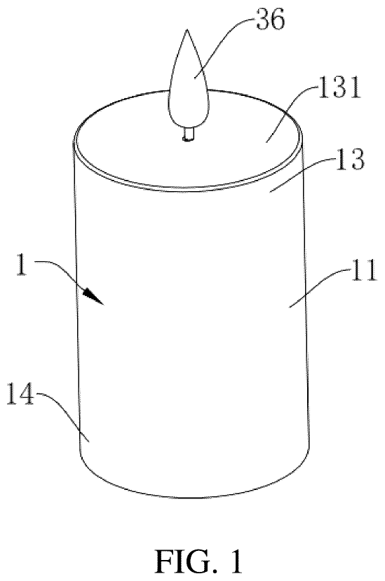

To solve the above technical problem, as shown in FIGS. 1, 2, 3, and 4, an embodiment of the present disclosure provides an electronic candle, including a paraffin housing 1 made of paraffin, which allows light to pass through. Structures inside the paraffin housing 1 cannot be clearly visible through the paraffin housing 1. The paraffin housing 1 includes an outer surface 11, in an embodiment, the outer surface 11 is a circumferential outer surface of the paraffin housing 1. A light string 2 is arranged inside the paraffin housing 1 and is arranged without protruding beyond the outer surface 11. The paraffin housing 1 has a hollow cavity 15, and the light string 2 may be arranged in the hollow cavity 15 or embedded in the paraffin housing 1, as long as the light string 2 does not penetrate the paraffin housing 1 to protrude out of the outer surface 11. The electronic candle further includes a core assembly 3 electrically connected to the light string 2. The core assembly 3 is configured to supply power for the light string 2 and control the light string 2 to be lit or extinguished. The paraffin housing 1 is made of paraffin which is light transmissive but not transparent. Therefore, when the light string 2 is lit, the light string 2 is not visible from an outside of the paraffin housing 1; and when the light string 1 is illuminated, light emitted from the light string 1 passes through the paraffin housing 1 to form illumination. The illumination is visible to users, however, the light string 2 is not visible, such that an aesthetic appearance of the electronic candle is enhanced. In addition, the light emitted from the light string 2 can be diffused through the paraffin housing, therefore, an area of the illumination is increased. Furthermore, due to a filtering effect of the paraffin housing, the light emitted from the light string 2 presents a hazy and soft visual effect.

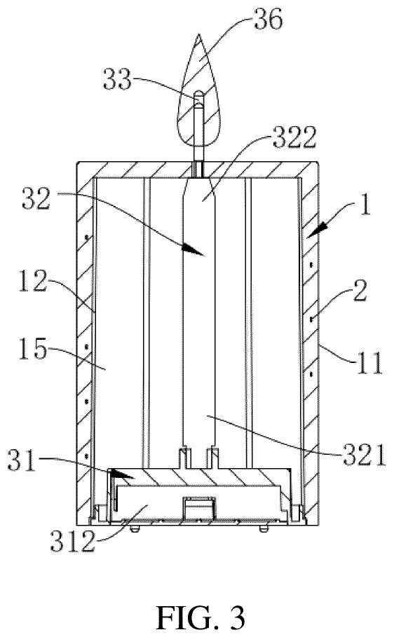

In an embodiment of the present disclosure, as shown in FIGS. 3, 4, and 5, the paraffin housing 1 is configured as a hollow structure to define an inner surface 12, and the light string 2 is arranged on the inner surface 12. In an embodiment, the inner surface 12 of the paraffin housing 1 is a circumferential inner surface, and the light string 2 can be arranged on the circumferential inner surface of the paraffin housing 1. It should be understood that the light string 2 may be entirely arranged within the hollow cavity 15 of the paraffin housing 1, for example, by being adhered to the inner surface 12; in other embodiment, at least a part of the light string 2 may be embedded in the inner surface 12. In other words, the light string 2 can be interpreted as being arranged on the inner surface 12 of the paraffin housing 1, as long as the light string 2 is in contact with the inner surface 12.

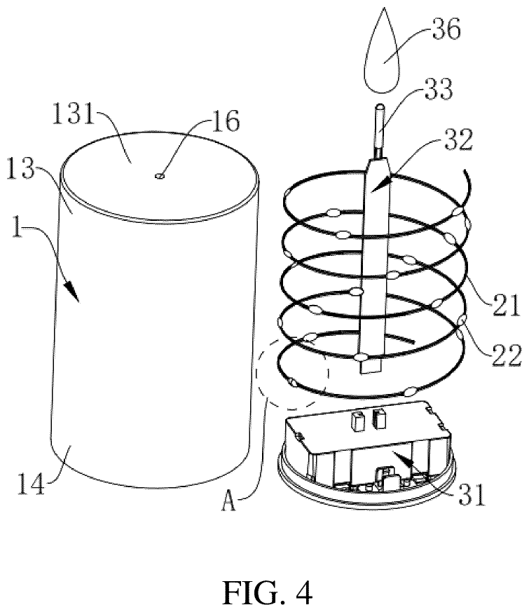

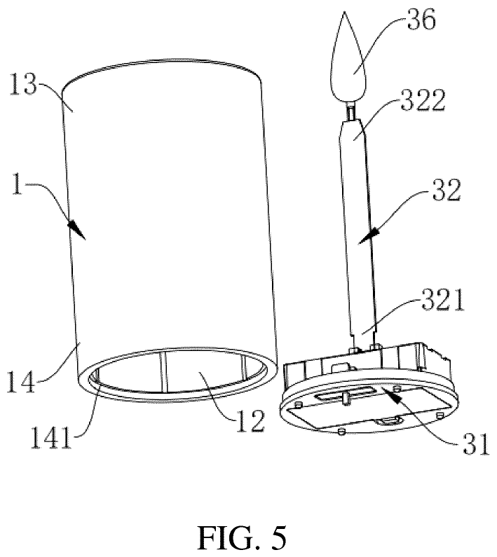

In an embodiment of the present disclosure, as shown in FIGS. 4 and 5, the light string 2 is attached to the inner surface 12 of the paraffin housing 1 by paraffin. Molten paraffin can be solidified after being cooled, therefore, before the molten paraffin solidifies, the light string 2 can be pre-arranged to be in contact with the molten paraffin, such that the light string 2 can be attached to the inner surface 12 during a solidification process, which simplifies the manufacturing of the paraffin housing 1 and the assembly of the light string 2.

In another embodiment of the present application, as shown in FIG. 3, the light string 2 can be arranged between the inner surface 12 and the outer surface 11. To be specific, the light string 2 is located between the inner surface 12 and the outer surface 11 of the paraffin housing 1, such that the light string 2 is neither exposed outside the paraffin housing 1 nor arranged inside the hollow cavity 15 of the paraffin housing 1. Therefore, the light string 2 can be prevented from being damaged by an external impact, and interference between the light string 2 and the core assembly 3 can be avoided when installing the core assembly 3 inside the paraffin housing 1. In addition, the stability of the light string 2 can be further improved. In this way, when the light is emitted from the light string 2 and passes through the outer surface 11 of the paraffin housing 1, the user can also see the illumination without seeing the light string 2.

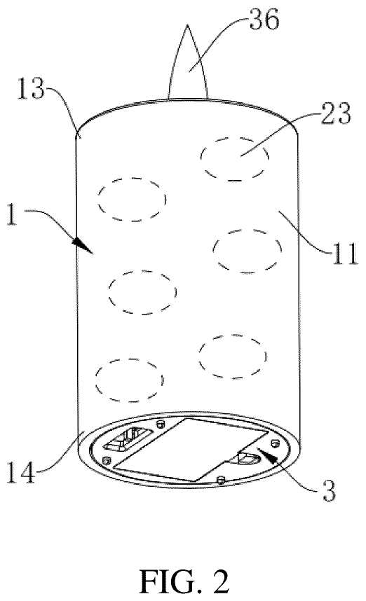

In an embodiment of the present disclosure, as shown in FIGS. 2 and 4, the light string 2 includes a plurality of light beads 21, and the plurality of light beads 21 can be sequentially connected by a wire 22. Light emitted from each of the plurality of light beads 21 respectively passes through the paraffin housing 1 to form a plurality of clump-shaped illumination zones 23. The light string 2 is disposed inside the paraffin housing 1, that is, the plurality of light beads 21 are distributed inside the paraffin housing 1. Each light bead 21 of the plurality of light beads emits light that passes through the paraffin housing 1 and forms a clump-shaped illumination zone 23. When viewed from a distance, the plurality of illumination zones 23 appear as stars suspended on the outer surface 11 of the candle, which further enhanced the aesthetic appeal of the electronic candle.

In an embodiment of the present disclosure, as shown in FIG. 4, the light string 2 includes the plurality of light beads 21, and each of the plurality of light beads 21 flickers according to a predetermined frequency to perform a breathing light effect, and the breathing light effect can be achieved by controlling the brightness variation of the light beads 21. The breathing light effect can be realized in various ways, such as using a processor (e.g., microcontroller, DSP, ARM, etc.) to control the light beads 21 to emit light or stop emitting light, or using a timer to generate pulse signals with a specific frequency to control light beads 21 to emit light or stop emitting light. Therefore, the electronic candle not only can provide a more realistic visual effect, but also can create a warm and soft vibe for users.

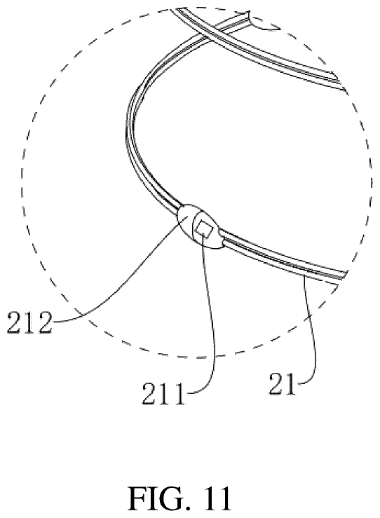

In an embodiment of the present disclosure, as shown in FIGS. 4 and 11, the light string 2 includes the plurality of light beads 21, and the plurality of light beads 21 emit light toward the outer surface 11. In an embodiment, the plurality of light beads 21 are configured as one-sided light, emitting elements, such that the light is emitted only from one side of each light bead 21 and is oriented toward the outer surface 11 of the paraffin housing 1. As a result, when the plurality of light beads 21 are lit, undesired light scattering within the paraffin housing 1 can be avoided, in this way, the light emitted from the plurality of light beads can be concentrated and projected toward the outer surface 11, to form the plurality of illumination zones 23 on the outer surface 11 with bright and focused effect. In addition, in order to achieve various lighting effects, a layout of the plurality of light beads 21 can be adjusted, and an emission angle of each light bead 21 can also be adjusted. For example, increasing the density of the plurality of light beads 21 can create a denser visual effect of the plurality of illumination zones 23; adjusting the emission angle of the light bead 21 can change a shape and a size of the corresponding illumination zone 23. In this way, different application scenarios and decorative requirements can be satisfied.

In an embodiment of the present disclosure, as shown in FIG. 11, each light bead 21 includes a lighting element 211 and an encapsulation layer 212 covering the lighting element 211. The lighting element 211 may be a light emitting diode (LED). The wire 22 includes a positive wire and a negative wire positioned parallel to the positive wire, and the lighting element 211 is electrically connected between the positive wire and the negative wire. The encapsulation layer 212 covers the lighting element 211 to encapsulate the lighting element 211 on the wire 22, ensuring mechanical strength and electrical insulation of the light bead 21. The encapsulation layer 212 may be made of epoxy resin, polyurethane, silicone and so on. In an embodiment, the encapsulation layer 212 protrudes toward the outer surface 11 of the paraffin housing 1. A protruding shape of the encapsulation layer 212 can adjust a propagation direction of the light emitted by the light bead 21, allowing the light to be more concentrated toward the outer surface 11, and the lighting effect and the visual effect of the plurality of light beads 21 can be improved. In some embodiments, the encapsulation layer 212 is configured to protrude unilaterally toward the outer surface 11 of the paraffin housing 1, in this way, the light can be more concentrated, and when the encapsulation layer 212 is embedded in the inner surface 12 of the paraffin housing 1, an inner structure of the paraffin housing 1 can be smoother.

In an embodiment of the present disclosure, the light string 2 is arranged in a crisscross winding layout along an axial direction of the paraffin housing 1. In an embodiment, a single light string 2 is wound back and forth along the axial direction of the paraffin housing 1, and also winds around the circumference of the paraffin housing 1, forming a crossed or X-shaped layout. The light string 2 includes a connection end and a winding end. In one embodiment, the connection end of the light string 2 is electrically connected to the core assembly 3, and the winding end is arranged inside the paraffin housing 1 in a crisscross winding layout along the axial direction. As a result, the light string 2 can be arranged more uniformly within the paraffin housing 1 to avoid overly concentrated lighting areas or shadowed areas.

In another embodiment of the present application, the light string 2 is arranged in a spiral layout along the axial direction of the paraffin housing 1. Similar to the above embodiment, the connection end of the light string 2 is electrically connected to the core assembly 3 for power supply and illumination. The winding end of the light string 2 spirally winds along the axial direction of the paraffin housing 1, and the light string 2 is wound uniformly and continuously until entire the light string 2 is wrapped around the paraffin housing 1. It should be understood that other winding configurations may also be adopted for the light string 2, depending on user preferences and the desired lighting effects.

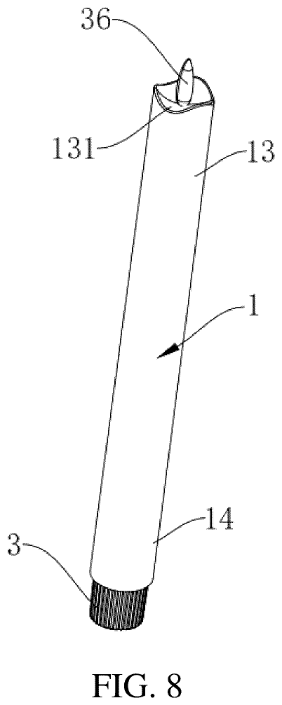

In an embodiment of the present disclosure, as shown in FIGS. 1 and 8, the paraffin housing 1 is configured as a cylindrical structure to simulate a shape of a real candle. The paraffin housing 1 may be formed as a slender cylinder or a short and thick cylinder, the dimension of the cylindrical structure can be flexibly adjusted according to different usage requirements.

In an embodiment of the present disclosure, as shown in FIGS. 3, 4, and 5, the core assembly 3 includes a battery compartment 31. The battery compartment 31 provides a mounting space for a battery 34 and also serves as a base for a PCBA 32. The paraffin housing 1 includes a first end 13 and a second end 14. The second end 14 is an open end, that is, an opening is defined at the second end 14 and is communicated with the hollow cavity 15 inside the paraffin housing 1. The battery compartment 31 is sealingly mounted at the second end 14 of the paraffin housing 1 to protect structures inside the paraffin housing 1. The hollow cavity 15 is defined inside the paraffin housing 1, and the PCBA 32 is inserted into the hollow cavity 15. The light string 2 is electrically connected to the PCBA 32. A control circuit is provided on the PCBA 32 and is configured to control the light string 2 to implement various lighting effects, such as breathing flicker, gradual brightness change, and so on.

In an embodiment of the present disclosure, as shown in FIGS. 4, 5, and 6, the PCBA 32 is configured as a strip structure. The PCBA 32 includes a third end 321 and a fourth end 322. The third end 321 is mounted on the battery compartment 31. A side of the battery compartment 31 facing the PCBA 32 has a slot 314, and the slot 314 may be formed by two U-shaped plates 315, the two U-shaped plates 315 are arranged oppositely with each other. The third end 321 of the PCBA 32 has a reduced width with which the PCBA 32 can be clamped into the slot 314. A light head 33 is arranged to be connected with the fourth end 322 of the PCBA 32. An end surface 131 of the first end 13 of the paraffin housing 1 has a through hole 16, and the light head 33 extends through the through hole 16. The light head 33 is capable of emitting light to simulate the real candle flame. The end surface 131 of the first end 13 of the paraffin housing 1 may be configured as a flat surface, or as an inclined surface, a curved surface, a wavy surface or a surface in other shapes.

In an embodiment of the present disclosure, as shown in FIGS. 5, 6, and 7, the core assembly further include a battery 34. A receiving cavity 312 is defined on a bottom surface 311 of the battery compartment 31. The battery compartment 31 protrudes inward into the paraffin housing 1 to form the receiving cavity 312. In an embodiment, an opening of the receiving cavity 312 is defined on the bottom surface 311 of the battery compartment 31. The battery 34 is disposed in the receiving cavity 312. A detachable cover 317 is detachably mounted on the opening of the receiving cavity 312 to enable the battery 34 to be installed within the receiving cavity 312. The core assembly includes electrode pieces extending through the battery compartment 31 and electrically connected to the battery 34. The electrode pieces are electrically connected to the PCBA 32 through a connecting wire, such that the battery 34 can supply power to the PCBA 32. An edge of the battery compartment 31 extends outward to form a protruding flange 313. A step surface 141 formed on an end surface of the second end 14 of the paraffin housing 1. The protruding flange 313 abuts against the step surface 141. That is, a portion of the inner wall at the second end 14 of the paraffin housing 1 is reduced in thickness to form the step surface 141, the step surface 141 may abut against the protruding flange 313, therefore, the bottom surface 311 of the battery compartment 31 is exposed to an outside of the paraffin housing 1, which facilitates replacement of the battery 34.

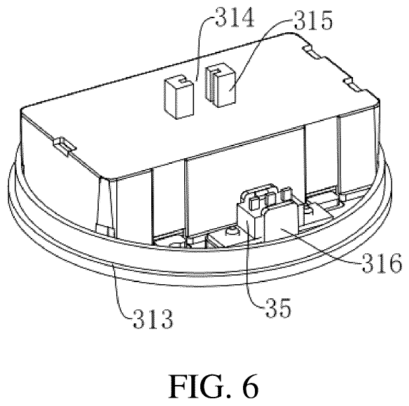

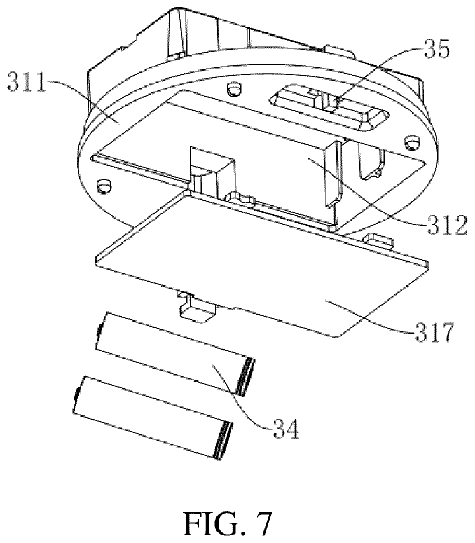

In an embodiment of the present disclosure, as shown in FIGS. 6 and 7, the electronic candle further includes a switch 35, and the switch 35 is mounted on the battery compartment 31. To be specific, a base 316 is arranged on a side of the battery compartment 31 facing the paraffin housing 1, and the switch 35 is installed in the base 316. The switch 35 may be a toggle switch or a press switch, the switch 35 has an operation key, the toggle switch or the press switch extends through the bottom surface 311 of the battery compartment 31 and is exposed from the bottom surface 311, such that the user can operate the switch conveniently. The battery 34 is electrically connected to the PCBA 32 through the switch 35. As a result, the user can operate the switch 35 to control the power supply of the electronic candle, ultimately controlling the light head 33 to be turned on or off.

In an embodiment of the present disclosure, as shown in FIGS. 4 and 6, when the switch 35 is turned on, the light string 2 and the light head 33 are simultaneously illuminated. At this time, not only the light string 2 can be lit up immediately, but the light head 33 also lights up at the same time, creating a coherent and natural lighting effect. When the switch 35 is turned off, the light string 2 and the light head 33 are simultaneously turned off, which ensures that no power is consumed when the electronic candle is in the off state, and potential safety risks caused by partial components remaining active can be avoided. A synchronous control mechanism of the electronic candle facilitates the user in use.

In an embodiment of the present disclosure, as shown in FIG. 4, the light head 33 is configured to flicker according to a predetermined frequency, which vividly simulates dynamic movement of a real flame and enhances visual authenticity of the light head 33. The predetermined frequency of the light head 33 may be synchronized with that of the plurality of light beads 21; for example, the flickering frequency of the light head 33 is equal to that of the light beads 21, resulting in a more coordinated and harmonious lighting effect.

In an embodiment of the present disclosure, as shown in FIG. 4, the electronic candle further includes a light head cover 36, which is capable of transmitting light and covers the light head 33. The light head cover 36 is configured as a flame-shaped conical structure. The light head cover 36 can be made of a soft silicone material which is translucent and opaque and is white in color. The light head cover 36 is sleeved over the light beads 21 to soften a grainy appearance of the light beads 21, such that the light emitted through the light head cover 36 can appear more gentle and diffused, similar to a glow of the real candle flame. In some embodiments, the light of the light head 33 is set to a warm white tone similar to that of the real flame, and can effectively simulate the color of a burning candle.

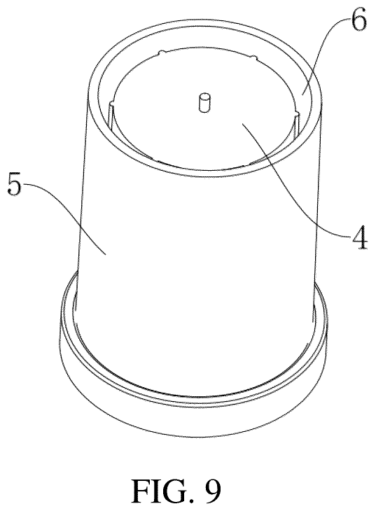

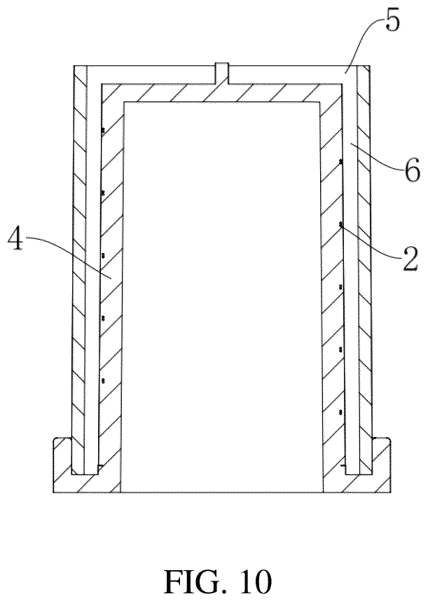

In an embodiment of the present disclosure, as shown in FIG. 9 and FIG. 10, a method for manufacturing an electronic candle is further provided, including the following steps:
S1: winding the light string 2 on the inner mold 4;
S2: sleeving the outer mold 5 over the inner mold 4 to define a mold cavity 6 between the outer mold 5 and the inner mold 4, a shape of the mold cavity 6 is identical to a shape of the paraffin housing 1, injecting molten paraffin into the mold cavity 6, and demolding the paraffin housing 1 after the paraffin is solidified;
S3: assembling the core assembly 3 onto the paraffin housing 1.

In step S1, the light string 2 is disposed on the inner mold 4. An outer shape of the inner mold 4 is identical to the inner surface 12 of the paraffin housing 1. The light string 2 can be winded in different manner, such as spiral winding or crossed winding. A winding density, spacing, and direction of the light string 2 may be adjusted according to specific design requirements. In step S2, the outer mold 5 is sleeved over the inner mold 4. An inner shape of the outer mold 5 is identical to an outer surface 11 of the paraffin housing 1. A mold cavity 6 is defined between the outer mold 5 and the inner mold 4. A shape of the mold cavity 6 is identical to a shape of the paraffin housing 1., and a size of the mold cavity 6 is identical to a thickness of the paraffin housing 1. Molten paraffin is injected into the mold cavity 6, and the paraffin gradually cools and solidifies in the mold cavity 6 to form the paraffin housing 1. After the paraffin is completely solidified, the inner mold 4 and the outer mold 5 can be separated, and the formed paraffin housing 1 can be removed. In step S3, the core assembly 3 is assembled onto the formed paraffin housing 1. The core assembly 3 includes a battery compartment 31 and a PCBA 32. In an embodiment, the battery compartment 31 is disposed at a second end 14 of the paraffin housing 1 to block the paraffin housing 1. The PCBA 32 is inserted into a hollow cavity 15 of the paraffin housing 1, and is electrically connected to the light string 2 to control the light string 2.

In an embodiment of the present disclosure, as shown in FIG. 4 and FIG. 5, after the paraffin is solidified, demolding and removing the paraffin housing 1 includes: when the paraffin housing 1 is removed, the light string 2 is adhered to the inner surface 12 of the paraffin housing 1. During the process of injecting the molten paraffin, the light string 2 is wound around a surface of the inner mold 4, and after the molten paraffin is cooled and solidified, the light string 2 can be removed together with the paraffin housing 1 from the inner mold 4 and the outer mold 5. Thus, in the subsequent assembling process, no additional fixing is required between the light string 2 and the paraffin housing 1, therefore, assembling steps can be simplified, a production efficiency can be enhanced. In some embodiments, the inner mold 4 is made of silicone, which is soft and elastic, and facilitates demolding. In addition, the inner mold 4 may also be made of plastic or aluminum. In some embodiments, the outer mold 5 is made of transparent acrylic, facilitating the user to observe a state of the molten paraffin in the mold cavity 6.

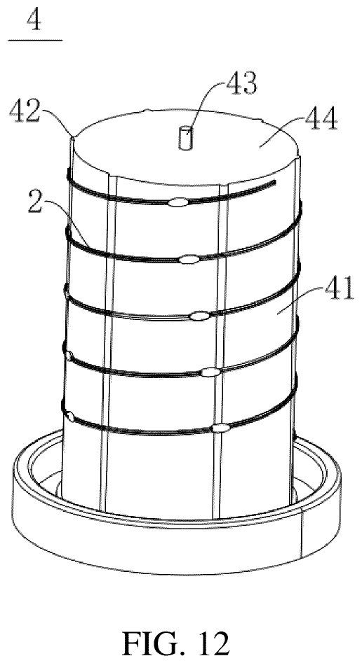

In an embodiment of the present disclosure, as shown in FIG. 12, the inner mold 4 includes the circumferential outer surface 41, and a plurality of protruding ribs 42 are arranged on the circumferential outer surface 41 of the inner mold 4. In some embodiments, the plurality of protruding ribs 42 are configured to be extends along a vertical direction and spaced apart with each other, and the light string 2 is wound around the plurality of protruding ribs 42. Accordingly, the plurality of protruding ribs 42 can lift the light string 2 toward the direction of the mold cavity 6, that is, the light string 2 can be remained inside the mold cavity 6, such that after molten paraffin is injected into the mold cavity 6, the light string 2 can be adhered to the paraffin housing 1 when the paraffin is solidified. The inner mold 4 further includes a top surface 44, and a protruding post 43 is arranged on the top surface 44. When molding the paraffin housing 1, a through hole 16 can be formed at the end surface 131 of the first end 13 by the protruding post 43.

Obviously, the embodiments described above are only a part of the embodiments of the present disclosure, and not all of them. The accompanying drawings give some embodiments of the present disclosure, but do not limit the patentable scope of the disclosure, which may be realized in many different forms. Rather, these embodiments are provided for the purpose of providing a more thorough and comprehensive understanding of the present disclosure. Although the present disclosure has been described in detail with reference to the foregoing embodiments, it is still possible for a person skilled in the art to modify the technical solutions recorded in the foregoing specific embodiments or to make equivalent substitutions for some of the technical features therein. Any equivalent structure made by utilizing the contents of the specification and the accompanying drawings of the present disclosure, directly or indirectly applied in other related technical fields, are all the same within the scope of the patent protection of the present disclosure.

What is claimed is:

1. An electronic candle, comprising:
a paraffin housing made of paraffin, the paraffin housing comprising an outer surface;
a light string arranged inside the paraffin housing without protruding out of the outer surface;
a core assembly electrically connected to the light string.

2. The electronic candle according to claim 1, wherein the paraffin housing is hollow and having an inner surface, and the light string is arranged on the inner surface.

3. The electronic candle according to claim 2, wherein the light string is affixed to the inner surface by the paraffin.

4. The electronic candle according to claim 1, wherein the paraffin housing is hollow and having an inner surface, and the light string is arranged between the inner surface and the outer surface.

5. The electronic candle according to claim 1, wherein the light string comprises a plurality of light beads, and light emitted from each of the plurality of light beads is capable of passing through the paraffin housing and form a clump-shaped illumination zone on the paraffin housing.

6. The electronic candle according to claim 1, wherein the light string comprises a plurality of light beads, and each of the plurality of light beads is configured to flicker according to a predetermined frequency to perform a breathing light effect.

7. The electronic candle according to claim 1, wherein the light string comprises a plurality of light beads, and the plurality of light beads are configured to emit light toward the outer surface of the paraffin housing.

8. The electronic candle according to claim 7, wherein each light bead of the plurality of light beads comprises a lighting element and an encapsulation layer covering the lighting element, and the encapsulation layer protrudes toward the outer surface of the paraffin housing.

9. The electronic candle according to claim 1, wherein the light string is helically extending along an axial direction of the paraffin housing.

10. The electronic candle according to claim 1, wherein the paraffin housing is configured as a cylindrical structure.

11. The electronic candle according to claim 1, wherein the core assembly comprises:
a battery compartment, wherein the paraffin housing comprises a first end and a second end, the second end has an opening, and the battery compartment is mounted at the second end to seal the opening of the second end;
a printed circuit board assembly (PCBA), wherein the paraffin housing defines a hollow cavity, and the PCBA is inserted in the hollow cavity, and the light string is electrically connected to the PCBA.

12. The electronic candle according to claim 11, wherein the PCBA comprises a third end and a fourth end, the third end is arranged on the battery compartment, the fourth end is connected to a light head, the first end of the paraffin housing has an end surface, and a through hole is defined on the end surface, the light head passes through the through hole.

13. The electronic candle according to claim 12, wherein the core assembly further comprises a battery, a receiving cavity is defined on a bottom surface of the battery compartment, the battery is disposed in the receiving cavity, an edge of the battery compartment extends outward to form a protruding flange, a step surface is formed at a second end of the paraffin housing, when the protruding flange abuts against the step surface, the bottom surface of the battery compartment is exposed outside the paraffin housing.

14. The electronic candle according to claim 13, wherein the core assembly further comprises a switch, the switch is arranged on the battery compartment, and the battery is electrically connected to the PCBA through the switch.

15. The electronic candle according to claim 14, wherein the light string and the light head are configured to be simultaneously lit when the switch is turned on, and the light string and the light head are configured to simultaneously stop emitting light when the switch is turned off.

16. The electronic candle according to claim 12, wherein the light head is configured to flicker according to a predetermined frequency to simulate a real flame.

17. The electronic candle according to claim 12, wherein the core assembly further comprises a light head cover which is capable of transmitting light, the light head covers the light head and is configured as a flame-shaped conical structure.
